(19) United States
(12) Patent Application Publication
(10) Pub. No.: US 2014/0074896 A1
(43) Pub. Date: Mar. 13, 2014

(54) System and method for data analysis and display

(71) Applicant: Partant Technology, Inc., Provo, UT (US)

(72) Inventors: Adam Bushman, Springville, UT (US); Dane Dellenbach, Pleasant Grove, UT (US); Bruce Hassler, Mapleton, UT (US); Tyson Holmes, American Fork, UT (US); Thomas Lane, Spanish Fork, UT (US)

(21) Appl. No.: 14/081,870

(22) Filed: Nov. 15, 2013

Related U.S. Application Data
(63) Continuation-in-part of application No. 13/348,221, filed on Jan. 11, 2012.
Application No. 13/348,221 is a continuation-in-part of application No. 13/188,393, filed on Jul. 21, 2011.
Application No. 13/188,393 is a continuation-in-part of application No. 13/709,293, filed on Dec. 10, 2012.
(60) Provisional application No. 61/787,715, filed on Mar. 15, 2013.

(51) Int. Cl. G06F 17/30

(52) U.S. Cl. CPC G06F 17/30292
USPC 707/805

(57) ABSTRACT

A system embodied on a computer-readable storage medium bearing computer-executable instructions that, when executed by a logic device, carries out a method for providing data for an organization. The system includes a logic device and one or more computer non-transitory readable media. The one or more computer readable media contain a set of computer-executable instructions to be executed by the logic device. The set of computer-executable instructions is configured to connect to a database over a network. The set of computer-executable instructions is also configured to obtain information from the database regarding an organization. The set of computer-executable instructions is further configured to display the information to a user.

### CROSS-REFERENCE TO RELATED APPLICATIONS

This non-provisional patent application claims the benefit of the filing date of U.S. Provisional Patent Application Ser. No. 61/787,715, which application was filed on Mar. 15, 2013, which application is now pending, and which application is incorporated herein by reference.

This non-provisional patent application is a continuation-in-part of U.S. patent application Ser. No. 13/348,221, which was filed on Jan. 11, 2012, which application is now pending, and which application is incorporated herein by reference.

U.S. patent application Ser. No. 13/348,221 is a continuation-in-part of U.S. patent application Ser. No. 13/188,393, which application was filed on Jul. 21, 2011, which application is now pending, and which application is incorporated herein by reference.

This application is also a continuation-in-part of U.S. patent application Ser. No.13/709,293, which application was filed on Dec. 10, 2012, which application is now pending, and which application is incorporated herein by reference.

### BACKGROUND OF THE INVENTION

1. Technical Field

The present invention relates generally to the field of data storage and manipulation and relates more particularly to the analysis and display of data used for organizational decision making.

2. Background Art

Organizations such as school districts and cities are increasingly trying to obtain additional data on their own performance and the performance of their constituents. For example, cities are increasingly interested in determining a cost-benefit analysis and the quality and quantity of communications between the city and the city's residents. Schools and school districts are increasingly trying to obtain additional data to monitor student performance. This data does not include just student grades or attendance, although that data is important as well. The data also includes how involved parents are with their children's education, how well the community is involved in schooling of children, how well educators are communicating with one another, with students and parents, and with the community.

However, this data is often hard to obtain. School districts may have different data collection systems, making it difficult for a government official, such as a mayor or governor interested in schools in distinct and separate school districts, to obtain relevant data for all children. Even the superintendent of a school district may have difficulty finding all of the relevant data for a school or a group of schools. Further, this can lead to an “apples-to-oranges” comparison where data is hard to reconcile and compare.

Moreover, systems for collecting different data may vary, meaning that the different data may not be available in a single location. For example, attendance data may be in one system, communication data in another system, and grade data in a third system, etc. This may mean that finding the desired data may require multiple logins to multiple systems. This leads to inefficiency and less monitoring of the data.

Accordingly, there is a need in the art for a system that can display relevant data in a single location. Moreover, there is a need in the art for system to be capable of displaying more detailed data if so required. Therefore, without additional improvements to the state of the art, timely access to relevant and valuable data will continue to be sub-optimal.

### BRIEF SUMMARY OF THE INVENTION

This summary is provided to introduce a selection of concepts in a simplified form that are further described below in the Detailed Description. This summary is not intended to identify all key features or essential characteristics of the claimed subject matter, nor is it intended to be used as an aid in determining the scope of the claimed subject matter.

One preferred exemplary embodiment of the present invention includes a system embodied on a computer-readable storage medium bearing computer-executable instructions that, when executed by a logic device, carries out a method for providing and analyzing data for one or more organizations. The system includes a logic device (e.g., microprocessor, central processing unit or CPU, etc.) and one or more non-transitory computer readable media. The one or more computer readable media most preferably contain a set of computer-executable instructions to be executed by the logic device. The set of computer-executable instructions is configured to connect to one or more databases over a network. The set of computer-executable instructions is also configured to obtain information from the database regarding an organization. The set of computer-executable instructions is further configured to display the information to one or more users.

Displaying the information to a user may include presenting a graphical user interface that includes multiple data sections, in the form of a “digital dashboard.” The multiple data sections are configurable and may be expanded to show additional data when an icon or hyperlink pertaining to the data section is selected by a user. This type of “drill down” analysis may be useful for decision-making processes in certain applications.

Additionally, a method of connecting one or more users to a database with information about an organization is provided. The method includes connecting to a user over a network, such as the Internet. The method also includes presenting selected data to one or more users over the network via the user interface. The selected data includes data relating to system usage by a multitude of users and information regarding an organization.

These and other objects and features of the present invention will become more fully apparent from the following description and appended claims, or may be learned by the practice of the invention as set forth hereinafter.

### BRIEF DESCRIPTION OF THE SEVERAL VIEWS OF THE DRAWINGS

To further clarify various aspects of some exemplary embodiment of the present inventions of the present invention, a more particular description of the invention will be rendered by reference to specific embodiments thereof that are illustrated in the appended drawings. It is appreciated that these drawings depict only illustrated embodiments of the invention and are therefore not to be considered limiting of its scope. Various preferred embodiments of the present invention will hereinafter be described in conjunction with the appended drawings, wherein like designations denote like elements, and:

FIG. 1 illustrates a block diagram of a system for data access and analysis in accordance with a preferred exemplary embodiment of the present invention;

FIG. 2 illustrates an example of a dashboard generated by a system for data access and analysis in accordance with a preferred exemplary embodiment of the present invention;

FIG. 3 illustrates an example of a dashboard generated by a system for data access and analysis in accordance with an alternative preferred exemplary embodiment of the present invention;

FIG. 4 illustrates an example of a suitable computing environment for implementing a system for data access and analysis in accordance with a preferred exemplary embodiment of the present invention;

FIG. 5 is a block diagram illustrating user interaction with a system for data access and analysis in accordance with a preferred exemplary embodiment of the present invention;

FIG. 6 is a flow chart of a method for using a system for data access and analysis in accordance with a preferred exemplary embodiment of the present invention;

FIG. 7 is a block diagram for organizational decision-making using a system for data access and analysis in accordance with a preferred exemplary embodiment of the present invention; and

FIG. 8 is a schematic representation for identifying and evaluating a response using a user interface in a system for data access and analysis in accordance with a preferred exemplary embodiment of the present invention.

### DETAILED DESCRIPTION OF THE INVENTION

Reference will now be made to the figures wherein like structures will be provided with like reference designations. It is understood that the figures are diagrammatic and schematic representations of some embodiments of the invention, and are not limiting of the present invention, nor are they necessarily drawn to scale. Any queries or code, which are disclosed, are non-limiting examples, which are not intended to limit the scope of the claims to any single embodiment.

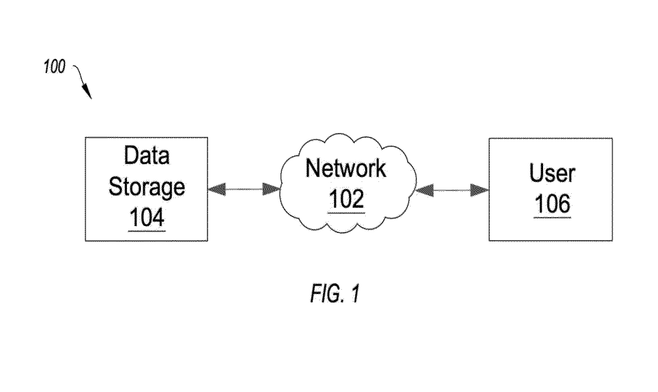

Referring now to FIG. 1, a block diagram of a network computer system 100 for obtaining data for an organization is illustrated. The data can be any desired data about the organization. For example, the data can include school data. The organization can include any desired organization. For example, the organization can include a city, company, school region or any other desired organization (e.g., if the organization is a school region, the school region can include any collection of one or more schools). Similarly, the organization can include a school, school district, schools within a city, county or state or any other desired collection of schools. Further, network computer system 100 can be configured to allow a user to select data to obtain more details if so desired. Additionally or alternatively, network computer system 100 can be configured to allow communication. For example, network computer system 100 can allow communication among school officials, from school officials to students, parents, community members and vice versa.

FIG. 1 shows that network computer system 100 can include a network 102. Network 102 can be used to connect the various parts of network computer system 100 to one another. Network 102 exemplarily includes the Internet, including a global internetwork formed by logical and physical connections between multiple wide area networks and/or local area networks and can optionally include the World Wide Web (“Web”), including a system of interlinked hypertext documents and web pages accessed via the Internet. Alternately or additionally, network 102 includes one or more cellular RF networks and/or one or more wired and/or wireless networks such as, but not limited to, 802.xx networks, Bluetooth access points, wireless access points, IP-based networks, or the like. For example, network 102 can include cloud based networking and computing. Network 102 can also include servers that enable one type of network to interface with another type of network.

FIG. 1 also shows that network computer system 100 can include a data storage system 104. Data storage system 104 can include any system capable of storing and retrieving the desired data. For example, data storage system 104 may include one or more electronic databases capable of electronically storing data (e.g., data storage system 104 can include memory or memory banks capable of transitory or non-transitory storage). Additionally or alternatively, data storage system 104 can include processors or other logic devices capable of executing software or carrying out other computer algorithms. Data storage system 104 can allow a user to access the hardware of data storage system 104 for remote computing or for information retrieval.

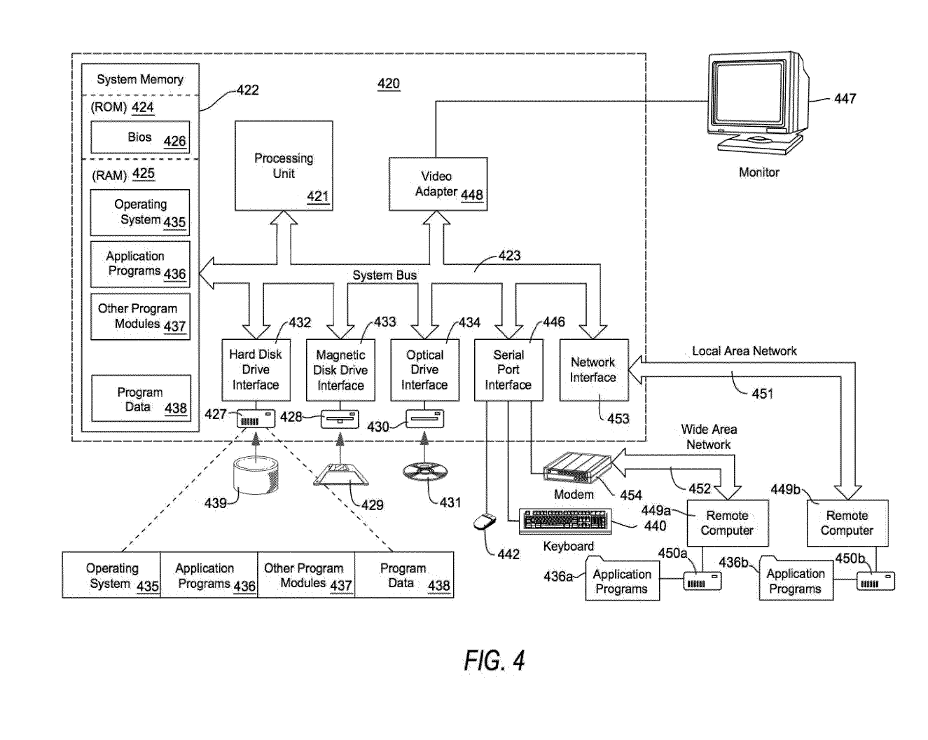

FIG. 1 also shows that network computer system 100 can include a user 106 connected to network 102. User 106 can include any entity connected over network 102 to data storage system 104. For purposes of this disclosure, user 106 can include any entity that wishes to retrieve some or all of the data stored in data storage system 104. For example, user 106 can include a school executive, a mayor, a superintendent, a school board member, a principal, a PTA president, a teacher, a student, a corporate executive, a designated administrator or any other desired user. Additionally or alternatively, user 106 can include a device, embodied in either software or hardware, which is connected to network 102 for purposes of retrieving, analyzing, and/or transferring some or all of the data stored in data storage system 104. FIG. 4 presents and expanded view of network computer system 100 and highlights additional components that may be included with network computer system 100.

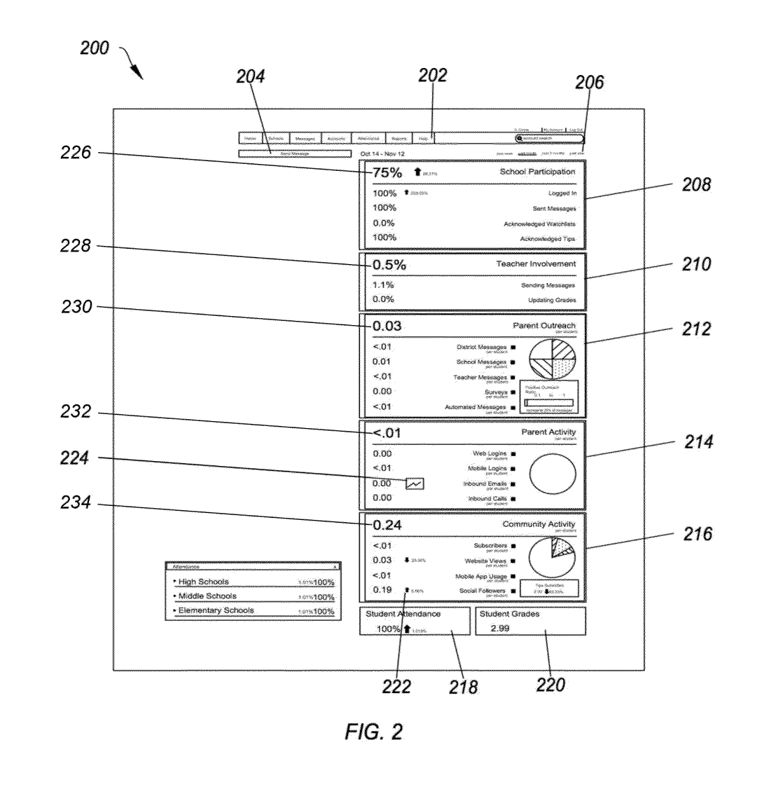

Referring now to FIG. 1 and FIG. 2, a user interface 200 representing a dashboard that allows user 106 to interact with network computer system 100 in accordance with a preferred exemplary embodiment of the present invention is illustrated. User interface 200 can provide information for user 106 to access in order to obtain desired data from a system. The data can allow user 106 to view statistics or information about a desired organization. For example, user interface 200 can provide multiple sources of data at a single point for user 106 to access. Although the example of user interface 200 is shown for a school region, those skilled in the art will understand that equivalent data can be presented for alternative organizations. For example, “attendance data” may refer to employee attendance in a typical office or similar work environment as well as student attendance in an educational environment such as an elementary or high school.

Those skilled in the art will appreciate that user interface 200 can be presented to user 106 as a dashboard. In at least one implementation, a dashboard can allow user 106 to view, hear or otherwise interact with user interface 200. In particular, a dashboard can allow a user or service provider to directly input or receive data into user interface 200 and the data can be stored in and retrieved from one or more databases stored on magnetic disk drive 439 of FIG. 4. One of skill in the art will appreciate that different user interfaces may be provided to allow users to interact with user interface 200 in a preferred manner. For example, user 106 can use a browser, mobile app, program, voice commands, text messaging, email or any other interface. User interface can include a graphical user interface, controls, speakers, displays or any other necessary hardware and/or software to adequately display desired information to user 106, as described below.

In at least one preferred embodiment of the present invention, a graphical user interface (“GUI”) is a type of user interface that allows users to interact with electronic devices with images rather than textual commands. GUIs can be used in computers, hand-held devices such as MP3 players, portable media file players or gaming devices, cell phones, tablets, household appliances, office equipment and any other desired device. A GUI represents the information and actions available to a user through graphical icons and visual indicators such as secondary notation, as opposed to text-based interfaces, typed command labels or text navigation. The actions are usually performed through direct manipulation of the graphical elements.

FIG. 2 shows that user interface 200 can include a menu 202 or toolbar. Menu 202 can allow user 106 to access other areas of interest. For example, menu 202 of FIG. 2 includes exemplary pages that user 106 may wish to access (e.g., FIG. 2 shows that menu 202 can include a home tab, a schools tab, a messages tab, an accounts tab, an attendance tab, a reports tab and a help tab, etc.). Although the word “tab” is used herein, one of skill in the art will appreciate that menu 202 can include buttons, links or any other desired mechanism for selecting the appropriate page. The home tab can allow user 106 to view the summary data when desired. The schools tab can allow user 106 to view information about individual schools—such as hours, contact information, etc.—or to view a subset of schools (e.g., a user can select individual schools or some combination of schools within the school region to view only data from the selected subset).

The messages tab may be configured to allow user 106 to send or receive messages using user interface 200. For example, the messages tab may be configured to allow user 106 to send messages to parents, administrators—such as teachers and/or principals—other users or any other desired mailing list. The accounts tab can allow user 106 to add, amend, or remove user privileges. For example, the accounts tab can allow user 106 to change user rights for other users, if so authorized. The attendance tab can allow user 106 to view attendance reports a group of students. For example, user 106 can create custom reports of students that should be watched closely, view attendance by school, grade or using any other desired group of students, including all students. The reports tab may also be configured to allow user 106 to create and/or view reports. The help tab may also be configured to allow user 106 to view information to assist user 106 in using user interface 200.

FIG. 2 also shows that user interface 200 can include a message button 204. Message button 204 may be configured to allow user 106 to compose messages to individuals or groups as desired. For example, message button 204 may allow user 106 to select from a library of messages and then send a customized message to a group of recipients. The individual or group receiving the message can be selected by a user from a list of individuals or groups that also contains the contact information for the individuals or groups.

Underneath time frame section 206, FIG. 2 shows a variety of sections, including one or more “metric data” sections. Metric data includes raw data and calculated metric data. Each metric data section is associated with a category. As used herein, “raw data” is data that has not been processed by network computer system 100 using an algorithm, has not been processed by any network computer system, or was processed by a third party, such as a third party school information system. As used herein, calculated metric data is metric data that is generated by the network computer system 100 applying metric data to an algorithm.

Some of the data shown in the data section, such as raw data related to student attendance, may be retrieved from the school's database. Some of the data, such as calculated metric data, is generated by network computer system 100 when it applies an algorithm to process or analyze the raw data. In some preferred embodiments of the present invention, calculated metric data may be generated by applying an algorithm to calculated metric data, to raw data, or to a combination of raw data and calculated metric data. Applied algorithms may use one or more weighting factors to give preference to certain sets of data when calculating the results. The weighting factors used in conjunction with the algorithms may be adjusted by user 106, depending on user configurable preferences.

For purposes of this disclosure, a “metric” is a class of desired measurements to be analyzed. A metric can be either what is measured by the data input into the database as raw data, or the meaning of an algorithm applied to some metric data, any mix of raw or calculated metric data, to generate new calculated metric data. Each data section may include a category of data, either narrow or broad including one or more metrics. The data section then displays the most up to date metric data or the metric data adjusted according to the time frame selected by user 106 using time frame selector 206.

If a metric data section includes calculated metric data calculated from more than one metric, an overall metric is assigned to be representative of the entire data section. This overall metric can be one of the metrics shown in the section or a different metric calculated from an algorithm that utilizes one or more of the other metrics in the data section. For example, an overall metric could be applied to all the data and other metrics that are generated by a school, giving administrators a quick view of the school's status or performance. The data section can be minimized to display only the overall metric or expanded to show all the selected metric data in that section. FIG. 2 shows all the sections with multiple metric data expanded.

FIG. 2 further shows that user interface 200 may include a time frame section 206. Time frame section 206 can allow user 106 to view data from a desired time period. For example, time frame section 206 may be configured to display data from the past week, past month, past 3 months, past year, a custom time period or any other desired time period.

FIG. 2 additionally shows that user interface 200 can include a school participation section 208. School participation section 208 can allow user 106 to view the overall usage of system by schools enrolled in system over the time period selected in the time period section 206 (e.g., school participation section 208 can allow user 106 to gauge which schools are using system and how comprehensive their use is). For example, school participation section 208 may be configured to include the following percentages and an average overall metric 226 for each of the following percentages: percentage of schools that have had at least one administrator log in; the percentage of schools that have had at least one administrator send a message; the percentage of schools who have had at least one administrator acknowledge a student on an attendance watch list; the percentage of schools who have had at least one administrator acknowledge a tip or any other desired school participation data. The school participation metrics may be used by administrators to quantify the amount of communication that the school makes to stakeholders.

FIG. 2 moreover shows that user interface 200 may be configured to include a teacher participation section 210. As used herein, teacher participation section 210 and parent outreach section 212 are specific examples of data sections. Teacher participation section 210 can allow user 106 to view the overall usage of system by teachers enrolled in system over the time period selected in the time period section 206 (e.g., teacher participation section 210 can allow user 106 to gauge which teachers are using system and how comprehensive their use is). For example, teacher participation section 210 may be configured to display at least the following percentages and an overall metric 228 for each of the following percentages: the percentage of teachers who have sent at least one message; and the percentage of teachers who have updated anything in their grade book or any other desired teacher participation data.

FIG. 2 also shows that user interface 200 can include a parent outreach section 212. Parent outreach section 212 can allow user 106 to view the overall outreach to parents by users enrolled in system over the time period selected in the time period section 206 (e.g., parent outreach section 212 can allow user 106 to gauge how effectively system is being used to communicate with parents).

For example, parent outreach section 212 may be configured to display at least the following metrics and an overall metric 230 for each of the following metrics: the average number of messages per student sent from the district; the average number of messages per student sent from schools; the average number of messages per student sent by teachers; the average number of surveys per student the district and schools have sent; the actual number of surveys which have been sent; the number of responses to surveys which have been received; the average number of responses to surveys per survey which have been received; the average number of automated messages per student (e.g., attendance, balance and transportation messages, etc.); the ratio of positive to negative messages (e.g., the percentage of messages that have a positive or negative bias; respective to all messages; the percentage under the bar shows what percentage of messages the ratio is responsible for); or any other desired parent outreach information. These ratios can also be combined, with one ratio divided into another ratio, to provide users with additional analytical tools. Surveys can also be used to establish baselines at a first point in time and then the same or a similar survey can be used to evaluate progress at a second point in time. Standardized test data may be used as an additional baseline to provide additional data for evaluation.

FIG. 2 further shows that user interface 200 can include a parent activity section 214. Parent activity section 214 can allow user 106 to view the overall usage of system by parents enrolled in system over the time period selected in the time period section 206 (e.g., parent activity section 214 can allow user 106 to gauge which parents are using system and how comprehensive their use is. For example, parent activity section 214 may be configured to display at least the following metrics and an overall metric 232 for each of the following metrics: the average number of web logins per student; the average number of mobile logins per student (e.g., the system tracks or counts system use with at least 60 minutes between uses as multiple logins, even if user 106 did not have to enter login ID/password data); the average number of inbound emails through system per student; the average number of inbound calls through system per student; or any other desired parental usage data.

FIG. 2 further shows that user interface 200 can include a community activity section 216. The community activity section 216 can allow user 106 to view the overall usage of system by members of the community enrolled in system over the time period selected in the time period section 206 (e.g., the community activity section 216 can allow user 106 to gauge how frequently the community is interacting with schools and the district). For example, the community activity section 216 may be configured to display at least the following metrics and an overall metric 224 for each of the following metrics: the number of community members who have voluntarily subscribed to receive messages from schools and the district (which may be normalized by a per student basis); the number of times a mobile app has been accessed per student, the combined number of followers on social media sites (e.g., number of Facebook® fans/likes, Twitter® followers, and YouTube® subscribers, of the district and school's social media pages—normalized by a per student basis) per student, the number of tips submitted over the specified reporting period or any other desired community activity. As used herein, “normalize” means to adjust total scores to account for the number of individuals which contributed to a score, such as by dividing a total score by the number of individuals who contributed to a score.

FIG. 2 additionally shows that user interface 200 can include an attendance section 218. Attendance section 218 can include the average daily attendance of students district-wide (e.g., the percentage of students who do not have an absence attendance code during a marking day). In particular, system can determine attendance “marking days” based on whether or not there is any attendance imported that day. If system determines that it is not a marking day for the school, the school's attendance percentage will not be applied to the district's value. For the district, a minimum number of schools must have a marking day for the data to be aggregated. For example, at least 75% of schools must be considered in a marking day for any attendance data to be aggregated for the district. The attendance codes considered “absence” may be configured on the ATTENDANCE>OPTIONS page. The attendance can be calculated using the method disclosed in U.S. patent application Ser. No. 13/188,393 incorporated herein by reference in its entirety.

Moreover, FIG. 2 also shows that user interface 200 can include a student grade section 220. Student grade section 220 can include the average grade to data for students district-wide. The grade can be converted to any desired scale. For example, the average grade can be converted to a 0-4 point scale (e.g., a point scale where an A is worth 4 points, B is 3, C is 2, D is 1, and F is 0, etc.).

FIG. 2 also shows that user interface 200 may be configured to calculate and display one or more trend lines 222. Trend lines 222 may be configured to display change in various data values relative to past data. For example, trend lines 222 can show the direction of change (e.g., an up arrow or down arrow) and/or the change in the value. This will allow user 106 to see the whether progress is being made in desired areas.

FIG. 2 also shows that user interface 200 can include an icon 224 that allows user 106 to obtain additional data. For example, icon 224 can include a graph or other symbol. Selecting the icon 224 can cause data to pop-up, which shows the data broken down into pre-set groups. For example, the data can be broken down into grade levels, schools, areas, student groups or any other desired break down.

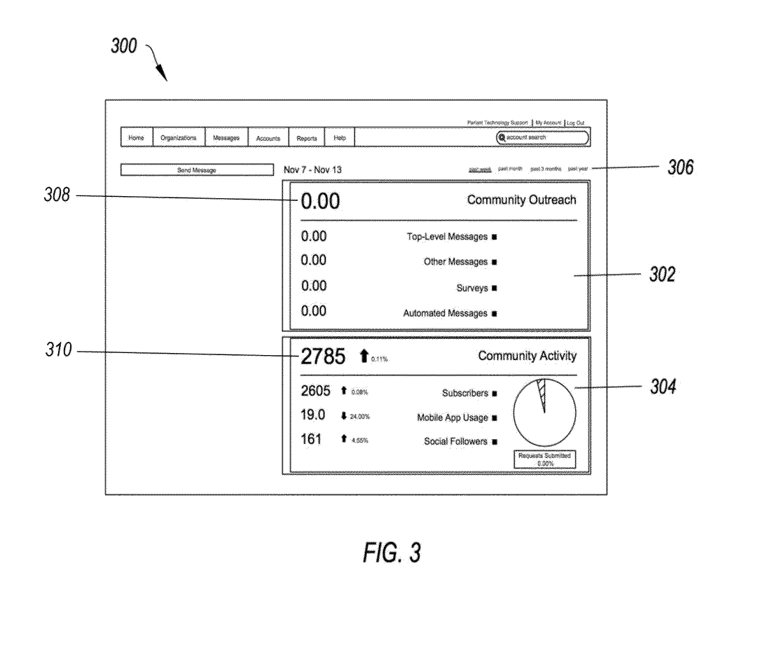

Referring now to FIG. 1 and FIG. 3, a user interface 300 which is presented as a dashboard that allows user 106 to interact with network-based system 100 in accordance with a preferred exemplary embodiment of the present invention is depicted. In this embodiment, user interface 300 has been configured for use by an executive of a governmental entity, such as the mayor of a city or the governor of state. For example, user interface 300 can allow the executive to access school data. Additionally or alternatively, user interface 300 can allow the executive to access data regarding to other aspects of the governmental entity.

FIG. 3 also shows that user interface 300 may include a community outreach section 302. Community outreach section 302 may be configured to display data related to efforts made by an organization such as a school or municipality to reach out to individuals or groups in the community associated with the school or municipality. For example, community outreach section 302 may be configured to display at least the following metrics and an overall metric 308: the number of top-level messages sent from the top-level of the organization (e.g., the mayor's office); the number of messages sent by other members of the organization; the number of surveys that have been sent; and the number of automated messages that have been sent.

FIG. 3 also shows that user interface 300 may include a community activity section 304. Community activity section 304 may be configured to display information about those members of the community who are actively seeking information from the community leadership. For example, community activity section 304 may be configured to display at least the following metrics and an overall metric 310: the number of consumers who receive mobile app messages; the number of consumers who use the organization's mobile app; and the number of consumers who follow the organization's various social media accounts. Those skilled in the art will appreciate that “consumers” can refer to individuals or organizations, such as parents or residents of a city who receive messages sent by an organization's administrator, such as a principal of a school or a city manager. Consumers may be also be “subscribers” where the term subscribers refers to individuals or organizations that have signed up to receive alerts about a certain website or who have installed the corresponding mobile app provided by the organization or municipality.

User interface 300 may also include a time frame section 306. Time frame section 306 can allow user 106 to view data from a desired time period. For example, time frame section 306 may be configured to allow user 106 to view data from the past week, past month, past 3 months, past year, a custom time period or any other desired time period.

Referring now to FIG. 1 and FIG. 4 a suitable computing environment in which the invention may be implemented is depicted. Although not required, the various preferred embodiments of the present invention will be described in the general context of computer-executable instructions, such as program modules, being executed by computers in network environments. Generally, program modules include routines, programs, objects, components, data structures, etc. that performs particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those skilled in the art will appreciate that the invention may be practiced in network computing environments with many types of computer system configurations, including personal computers, hand-held devices, mobile phones, multi-processor systems, microprocessor-based or programmable consumer electronics, network PCs, minicomputers, mainframe computers, and the like. The invention may also be practiced in distributed computing environments where tasks are performed by local and remote processing devices that are linked (e.g., using hardwired links, wireless links, or by a combination of hardwired or wireless links) through a communications network. In a distributed computing environment, program modules may be located in both local and remote memory storage devices.

As shown in FIG. 4, an exemplary system for implementing the invention most preferably includes a general purpose computing device in the form of a conventional computer 420, including a processing unit 421, a system memory 422, and a system bus 423 that couples various system components including system memory 422 to the processing unit 421. It should be noted however, that as mobile phones become more sophisticated, mobile phones are beginning to incorporate many of the components illustrated for conventional computer 420. Accordingly, with relatively minor adjustments, mostly with respect to input/output devices, the description of conventional computer 420 applies equally to mobile phones. System bus 423 may be any of several types of bus structures including a memory bus or memory controller, a peripheral bus, and a local bus using any of a variety of bus architectures. System memory includes read only memory (ROM) 424 and random access memory (RAM) 425. A basic input/output system (BIOS) 426, containing the basic routines that help transfer information between elements 100 within computer 420, such as during start-up, may be stored in ROM 424.

Computer 420 may also include a magnetic hard disk drive 427 for reading from and writing to a magnetic hard disk 439, a magnetic disk drive 428 for reading from or writing to a removable magnetic disk 429, and an optical disc drive 430 for reading from or writing to removable optical disc 431 such as a CD-ROM or other optical media. The magnetic hard disk drive 439, magnetic disk drive 428, and optical disc drive 430 are connected to system bus 423 by a hard disk drive interface 432, a magnetic disk drive-interface 433, and an optical drive interface 434, respectively. The drives and their associated computer-readable media provide nonvolatile storage of computer-executable instructions, data structures, program modules and other data for computer 420, including one or more databases containing relevant data for users, organizations, etc. Although the exemplary environment described herein employs a magnetic hard disk 439, a removable magnetic disk 429 and a removable optical disc 431, other types of computer readable media for storing data can be used, including magnetic cassettes, flash memory cards, digital versatile discs, Bernoulli cartridges, RAMs, ROMs, and the like.

Program code comprising one or more program modules may be stored on the hard disk 439, magnetic disk 329, optical disc 431, ROM 424 or RAM 425, including an operating system 435, one or more application programs 436, other program modules 437, and program data 438. A user may enter commands and information into computer 420 through keyboard 440, pointing device 442, or other input devices (not shown), such as a microphone, joy stick, game pad, satellite dish, scanner, motion detectors or the like. These and other input devices are often connected to the processing unit 421 through a serial port interface 446 coupled to system bus 423. Alternatively, the input devices may be connected by other interfaces, such as a parallel port, a game port or a universal serial bus (USB) port. A monitor 447 or another display device is also connected to system bus 423 via an interface, such as video adapter 448. In addition to the monitor, personal computers typically include other peripheral output devices (not shown), such as speakers and printers.

Computer 420 may operate in a networked environment using logical connections to one or more remote computers, such as remote computers 449a and 449b. Remote computers 449a and 449b may each be another personal computer, a server, a router, a network PC, a peer device or other common network node, and typically include many or all of the elements 100 described above relative to computer 420, although only memory storage devices 450a and 450b and their associated application programs 436a and 436b have been illustrated in FIG. 4. The logical connections depicted in FIG. 4 include a local area network (LAN) 451 and a wide area network (WAN) 452 that are presented here by way of example and not limitation. Such networking environments are commonplace in office-wide or enterprise-wide computer networks, intranets and the Internet.

When used in a LAN networking environment, computer 420 can be connected to the local network 451 through a network interface or adapter 453. When used in a WAN networking environment, computer 420 may include a modem 454, a wireless link, or other means for establishing communications over the wide area network 452, such as the Internet. The modem 454, which may be internal or external, is connected to system bus 423 via the serial port interface 446. In a networked environment, program modules depicted relative to computer 420, or portions thereof, may be stored in the remote memory storage device. It will be appreciated that network connections shown are exemplary and other means of establishing communications over wide area network 452 may be used.

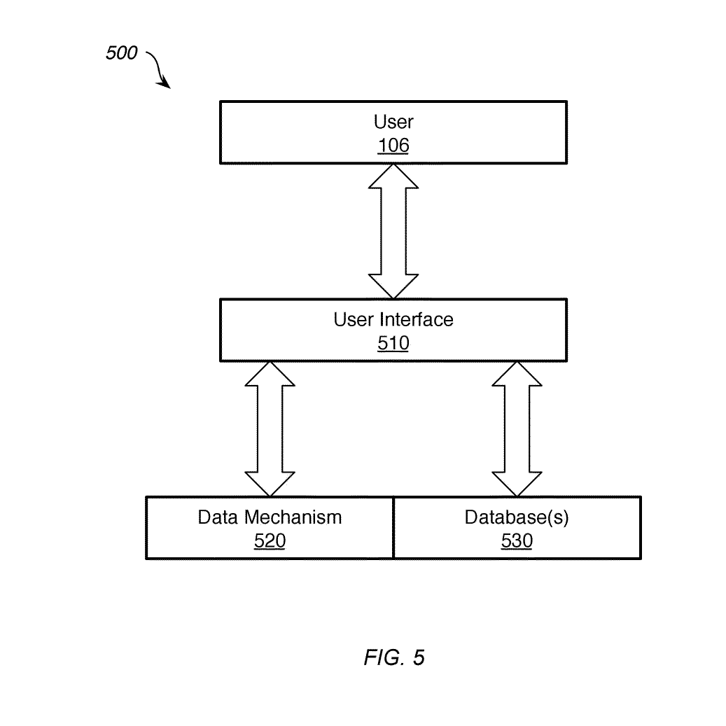

Referring now to FIG. 1 and FIG. 5, user 106 will interact with user interface 510. User interface 510 is typically a program module or component stored in database(s) 530. By accessing user interface 510, user 106 can input and modify the data contained in database(s) 530, which may be stored on hard disk drive 439. User 106 can also interact with data mechanism 520 to receive information regarding potential attendance related problems and responses. Data mechanism 520 will access the data contained in database(s) 530 and display data in a dashboard view similar to user interface 200 of FIG. 2 generated by user interface 510 for review by user 106. Additionally, data mechanism 520 will access the data contained in database(s) 530 and monitor user-definable performance metrics and propose possible responses to various organizational problems and provide this information to user 106 via user interface 510. The responses may be based on the organizational metrics or a broader range of aggregated metrics gathered from similar organizations.

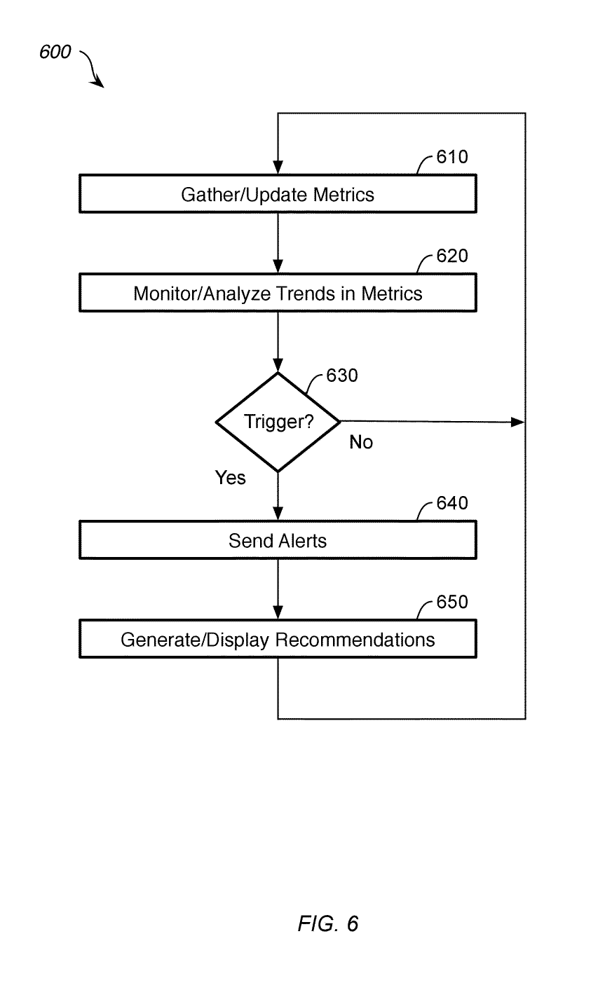

Referring now to FIG. 1 and FIG. 6, a method 600 for using network computer system 100 for data access and analysis in accordance with a preferred exemplary embodiment of the present invention is depicted. As shown in FIG. 6, network computer system 100 will gather and update the performance metrics that have been identified as being relevant to the organization (step 610). Network computer system 100 may also be configured to continually monitor and analyze the organizational metrics (step 620) and determine if any user defined threshold has been triggered (step 630).

If no pre-determined threshold has been triggered (step 630=“No”) then network computer system 100 will simply continue to gather/update the metrics (step 610) and monitor/analyze trends in the metrics (step 620). However, once a threshold has been triggered (step 630=“Yes”), network computer system 100 will issue the number and type of alerts that have been configured by the administrators and users of network computer system 100 (step 640) and generate and/or display recommendations to deal with the trends that caused the threshold to be triggered (step 650). The displayed results may be graphical representations of the trends and metrics (graphs, etc.) or simply textual information that will allow the users to ascertain the source of the alerts.

It should be noted that the number and type of performance metrics to be monitored are typically selected based on specific organizational needs and goals as well as industry standards. For example, a business may focus on financial metrics and goals while an educational institution may focus on attendance and grades and establish their metrics accordingly. Industry wide averages for financial performance (e.g., marginal costs, marginal revenue, Cost of Goods Sold, etc.) may be established as threshold triggers that generate alerts for business owners and senior management.

Similarly, for an educational institution, if a user definable performance threshold (e.g., average class attendance for a student population) is triggered, multiple alerts may be automatically generated by network computer system 100. A system administrator can configure network computer system 100 so that an individual or a group of individuals (e.g., the teacher for the class, the school principal, or a district superintendent) receives the alert such as a SMS text message, an email message, a phone call, etc.

Similarly, system users may be automatically and dynamically assigned to groups by network computer system 100 and selected to receive system-generated alerts, based on one or more performance metrics. For example, if the system administrator sets a performance metric that requires student grades to be updated on a weekly basis, any teacher that fails to update the student grades in a timely fashion will be automatically included in a group with other teachers that have also failed to update student grades. This group may change on a weekly basis, without any human intervention.

Further, the system may have a series of alert triggers for actions for each member of various groups, based on trigger actions that determine group membership. So, for example, network computer system 100 may be configured to send a first weekly message to all teachers in the group that has failed to update the student grades (e.g., a reminder to update the student grades) and send a different weekly message to those teachers in the group of teachers that have updated the student grades in a timely fashion (e.g., a “thank you” message). As previously mentioned, the actual number and identity of the teachers in each of these groups may vary from week to week, based on actual performance. These messages and alerts may be based on one or more preconfigured templates.

In addition to generating preconfigured alerts, network computer system 100 is configured to use the metrics gathered in step 610 in other ways. For example, a “metric builder” capability allows users to “designate a metric” which means to instruct network computer system 100 to create a new metric and a new algorithm for generating the metric, which may be the ratio of two user-selected metrics or a more complex algorithm by selecting any measured statistic and configuring network computer system 100 so that it will display the statistic as a ratio of a different statistic or as a ratio for a user configurable time period. “Calculate data for a designated metric” is to calculate data by applying metric data to an algorithm which is associated with the designated metric. Using the metric builder, a user in an educational environment could select statistics of interest from the database (e.g., the number of absences by students who speak English as a second language) and a time period for measuring the first statistic (e.g., a 30 day period), and then instruct the system to divide the first statistic by a second statistic such as the number of absences by students who do not speak English as a second language during a 30 day period. Dividing that number by 30 days would yield a daily average that could be tracked and reviewed over time.

For example, it is possible to measure the number of individuals with characteristic A and characteristic C during time period D and then divide that number by the number of individuals with characteristic A. Similarly, the number of individuals with characteristic B and characteristic C during time period D could be divided by the number of individuals with characteristic B for the same or a different time period, to measure change over time and verify or validate the efficacy of the measures implement in response to the metrics of interest. In this way, correlation and causation cat be more closely identified.

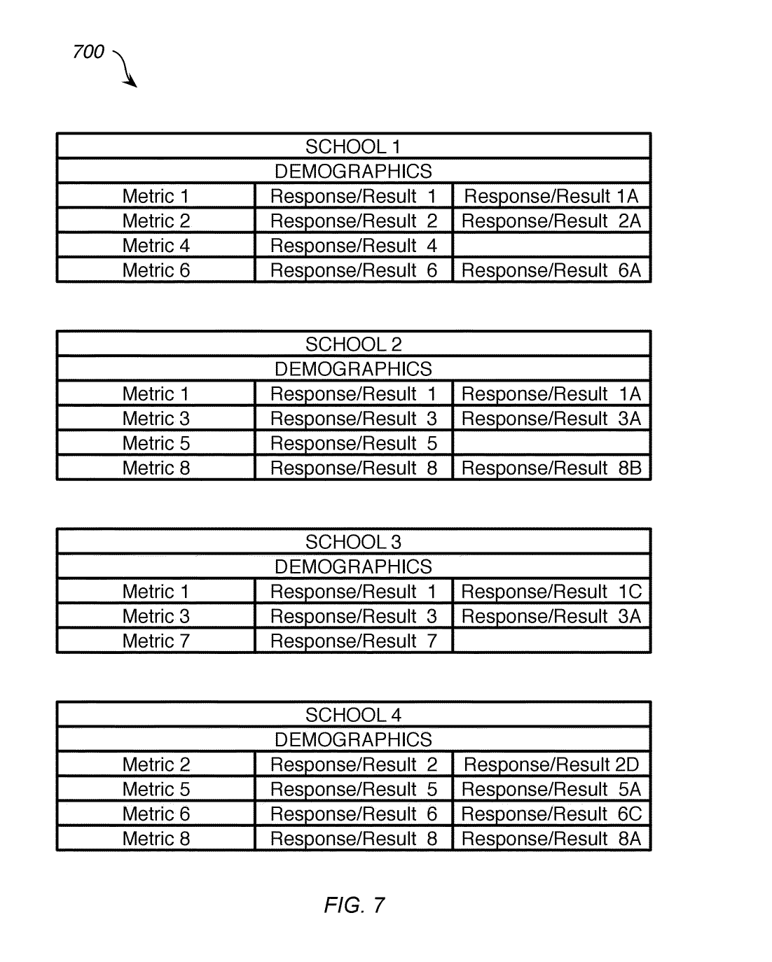

Referring now to FIG. 7, a block diagram 700 for analyzing trends and generating possible responses to organizational issues using a system for data access and analysis in accordance with a preferred exemplary embodiment of the present invention is depicted. As shown in FIG. 7, a number of schools have been tracking various metrics (areas of interest for the school) and the responses or actions taken with regard to each metric that has been advanced as an item of interest or concern. The system can also use the date that an action was taken when tracking changes in metric data to later show how effective a particular action can be in responding to particular problems. This information may be very useful for a teacher or school administrator when deciding an appropriate course of action for their school.

As shown in FIG. 7, the specific metrics of concern or interest for each school and each school's response to similar items of concern or interest will vary from school to school. Regardless, the metrics and responses for multiple schools can be tracked and stored in a database and used for analysis and decision making by other schools. For example, with a large enough population of schools in the database, the system could automatically locate schools with similar demographics, similar metrics, and highlight the metrics of concern at each school (positive or negative trends of interest) and then suggest appropriate actions for an administrator at a school. In this fashion, a school administrator can see how other schools with similar profiles and metrics have chosen to address areas of interest and concern. It would also be possible to use multiple schools to create a “best fit” analytical model for another school if no single school provides a close enough match from a statistical perspective. The administration for a school can track trends over time as a result of various initiatives or actions adopted by other schools and use this information to create an action plan for their school.

Users of the various preferred embodiments of the present invention can configure the system to automatically configure the dashboard or other portions of the system to display information from other software products and service, such as a communication or messaging platforms or related application based on changes to metrics. For example, when student grades drop below a certain threshold, the system can be configured so that the dashboard will begin showing additional metrics (which are optionally user-configurable) such as average grades for ninth graders, average grades for tenth graders, average grades for athletes, etc.

For example, if the number of logins to the system by consumers via the mobile device application is less than a pre-determined threshold, the system can automatically prepare a message to be sent out to one or more automatically created groups. The user can send the message from the dashboard or select the message and then view and send the message via an application program interface (“API”) for another messaging application. Alternatively, the system can prepare a message that will be seen by the user when the user opens up a related messaging application.

In yet another preferred embodiment of the present invention, the system will allow the users to connect with an anonymized social network and review relevant statistics and metrics from related individuals and/or organizations to provide a broader base of aggregated statistical data from which to draw conclusions and generate potential remedial or corrective actions. In this embodiment, the performance metrics for other organizations that are using the system can be aggregated for a variety of analytics and reporting purposes, including generating suggestions for process improvement.

The purpose of this social network is to allow a manager or administrator to get recommendations and learn how other managers and administrators at different organizations responded to similar trends in dashboard metrics. Trends can be calculated as a range, that is, receiving a metric that is within a certain range. (Or this may be historical data-what did the superintendent do 5 years ago to respond to a decrease in a certain dashboard metric). For example, if a dashboard metric decreased for administrator A and on average administrators at different organizations responded by sending out a certain type of message, then the system could display an anonymized version of the message and optionally context behind the message such as: In a sample of 10 school districts with similar demographics to your school district who faced a decrease in student's earned grades, the favorite course of action was to send a message to the students and the student's parents and this data may be cross referenced with other data including census data, median income, geographic location, etc.

Alternatively, the system can display the action or actions that were implemented by other similarly situated organizations in response to similar metrics, particularly with regards to actions that improved the target metric in response to the actions taken. While co elation is not always proof of causation, when metrics and responses from other school districts that faced a similar scenario are evaluated, it may be possible to identify potential solutions that will be viable solutions another school. This type of data could be presented without necessarily providing any information that could be used to identify the school or school district. Alternatively, the system can track the changes to the specific metric after the course of action and list the course of action in which the course of action had a positive effect such as increasing student grades.

Alternatively, administrators can make notes on what type of actions they used to respond to a dashboard metric and the notes can be shared with other administrators in different organizations via the system who face similar trends. Alternatively, the course of action can include sending out surveys and the course of action can be ranked based on the degree to which the aggregate feedback is positive. Thus, the system could share the following sample text: Your organization is experiencing a decline in Metric A.

Some organizations with similar demographics were faced with a similar trend, and in response to the decline, the organizations that performed action B had the best effect as measured by the results of parent surveys. Alternatively, administrators at different organizations who are using the same system on the same network can opt to “share” with each other how they responded to different trends in dashboard metrics. When the two administrators agree to share, then the two administrators can view each other's contact information. Some preferred embodiments of the present invention are configured to allow communication between the administrators. In some embodiments, the two administrators can agree to share but they still gain anonymous to each other. Some of these preferred embodiments will also allow for messages to be distributed via an anonymous messaging system.

Administrators can also configure network computer system 100 to “follow” (e.g., receive updates about or otherwise review the actions taken by other organizations selected on the basis of similar demographics such as teacher-student ratios, number of students in the organization, location of the organization in a geographical area. Network computer system 100 may be configured to analyze other organizations to find those with similar demographics or metrics and recommend them to the Administrators to “follow”. The suggestions can also be based on organizations that have taken similar actions in the past. Each user and each school or school district can elect whether or not to allow their activities to be followed and the identity of each user will be shielded unless the user explicitly “opts in” to permit following by other users. Additionally, network computer system 100 may provide for aggregation of the metrics and associated responses while maintaining secrecy regarding the identity of the users and the schools or school districts. It is important to note that the aggregated dataset will allow a school to find one or more schools with a similar school profile and use the system to make a suggestion for similar goals to improve similar or related metrics.

Alerts may be displayed on a dashboard such as user interface 200 of FIG. 2 when numbers fall within a certain range (for example, the number of parent activity data fails below 1000), then the administrator is either automatically shown a drop down menu or is displayed a button that when pressed will display the drop down menu; the drop down menu being configured to provide an expandable list of recommended actions on how the administrator could respond to the trend such as by sending a message to a certain group of message recipients or viewing a watch list of individuals or students who contributed to the change in the trend; administrators can 1) select the recommended action and network computer system 100 will display a user interface such as a GUI associated with user interface 200 where the administrator can perform the recommended action, 2) initiate the recommended action, 3) plan the recommended action or some other action, 4) report on a completed action.

For example, as part of the system configuration to identify the data to be gathered, user 106 may have configured network computer system 100 to identify low grades as an important metric. In this case, the attendance metric could be displayed on user interface 200 of FIG. 2 whenever attendance drops below the pre-determined threshold trigger percentage. Based on this user-identified metric, a school administrator may elect to take one or more actions or implement one or more strategies in response. Some possible responses to the low grade metric may include: sending a message to the parents of the students with low grades; inviting the counselors to schedule an appointment with the students whose grades have dropped below the accepted threshold; provide access to tutoring for those students whose grades have dropped below the accepted threshold; etc. It should be noted that the response for each school might be different, even if the metrics are similar because the resources for each school may be different and the demographics for the student population at each school may be different, etc. Additionally, based on each of these variables and the demographics of the school as well as the training and background of the school administrators, a different set of responses to address the situation may be selected by the administration at each school.

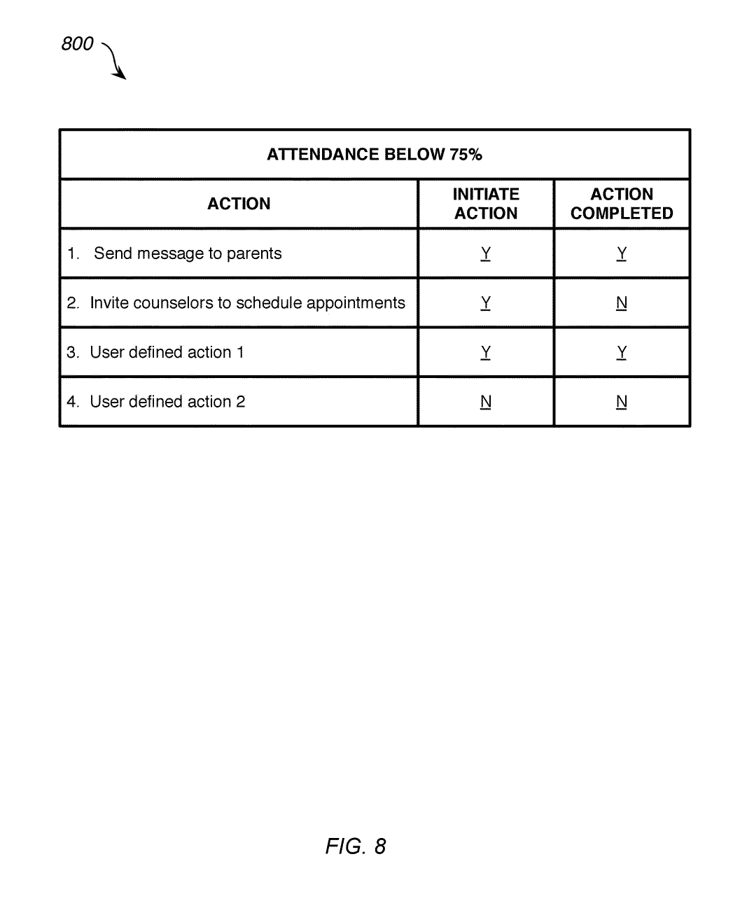

Referring now to FIG. 8, a user interface 800 (which may be a subset of the user interface displayed by user interface 200 of FIG. 2) can be accessed to allow user 106 to interact with network computer system 100 to create, monitor, or evaluate user-initiated responses to the e metrics of interest. User interface 800 displays a series responses which may be programmatic generated responses that are automatically displayed in user interface 800 based on the responses of other, similarly situated schools or school districts or user generated responses that are created by the users to address their specific circumstances. In the case of user interface 800, both types of responses to the low attendance metric have been included.

As shown in FIG. 8, the attendance metric for a school or school district has dropped below 75% where 75% is the trigger threshold established by the school or school district. Each column in the tabular display of user interface 800 may also contain a hyperlink that allows the user to evaluate and monitor the responses to the attendance metric. In this fashion, a supervisor or administrator can repeatedly check and monitor the status of responses to the attendance metric.

For example, whenever a user selects the “Y” hyperlink in the “Initiate Action” column that corresponds to the “Send message to parents” row, then network computer system 100 is configured to display a user interface for sending a message to the automatically generated group of parents or guardians of those students whose attendance has dropped below the 75% trigger threshold. The email address of each parent or guardian may be extracted from data storage system 104 of FIG. 1 and used to send the message. User 106 may then compose the message and the system will then automatically send it to the parents.

Additionally, if an action has been completed, Network computer system 100 may be configured to set a flag to indicate that the action has been completed. For example, if the administrator selects the “Y” hyperlink in the “Action Completed” column and the “Send messages to parents” row, the administrator can then indicate to network computer system 100 that the administrator or someone who else at the organization has already performed the action. In some preferred embodiments of the present invention, for system generated actions, a completed flag may be automatically set once the action has been completed (e.g., after the email is sent, the flag is automatically set by the parents). For other actions, such as call the parents, network computer system 100 may not have any notification regarding the completion of the action and the completed flag will be set manually.

The user defined options for response to a metric may include one or more actions or group of actions such as “Send messages to the parents of students with low grades until the parents reply”, “Send 3 messages to the parents”, and “Schedule meeting with parents of students with accommodations and low grades.” The user or the administrator can define the response items and schedule the response for completion as desired.

The most preferred embodiments of network computer system 100 will include multiple templates, with the templates being provided by the system and/or created by users. The templates, regardless of the origin, can be tied to specific metrics and issued automatically or on an ad-hoc basis by the users. For example, an email template may be provided to attendance tracking and an email message can be generated whenever the attendance metrics being tracked by the system exceed the trigger thresholds established by the users of the system. Similar templates may be provided for “snail mail” messages as well as automated phone messages, etc.

In most preferred embodiments of the present invention, network computer system 100 also creates a log of the various actions and displays an interface that accepts information from the user about various actions that were completed in response to dashboard trends. The interface may be configured to capture and display the date, the name of the person who completed the action, and continue to track the changes to the metric from the date that an action was completed for analysis over time. This allows for segmenting the metrics and the responses by time, to provide the ability to select and display one or more time periods for analytical reporting purposes.

In certain preferred exemplary embodiments of the present invention, administrators can select the start date for a response action and select a target date for sending a reminder if it hasn't selected a finish date for the action. For example, an administrator may initiate on February 15^{th} from the dashboard the action of inviting counselors to schedule appointments with students who contributed to the trend in the metric (or who contributed “the most” to the trend such as the students who had the largest drop in grades), with a target date for completing the first stage (e.g., having counselors scheduled appointments with students) and also configure the system to remind the administrator on a certain date such as March 15 if the appointments have not been scheduled and another reminder to be sent by May 15 if the appointments have not been scheduled. The administrator may also configure the dashboard so that it shows an up-to-date number figure or graph showing the progress in the number of appointments scheduled by counselors or the number of appointments which were actually scheduled.

Users can also configure network computer system 100 to send out automated surveys that have been divided into specific survey categories that correspond to categories displayed by the dashboard. Network computer system 100 suggests different surveys and groups of intended recipients for the surveys based on the trends of the dashboard. For example, the system may determine that the number of social media followers is down. Network computer system 100 then may select from a group of survey questions categorized as “social media” and suggest that the administrator send out survey questions such as “How often do you use mobile apps?” and “Please tell us the main reasons why you would use the mobile app: to check grades, to check the calendar, etc.” Network computer system 100 then suggests that the administrator send out the surveys to individuals or associates of the individuals who are impacting the trend or to random individuals or associates of the individuals at a rate that will result in a statistically significant number of surveys.

For example, if a teacher sends out a message, network computer system 100 can then send up a follow up question to the recipient asking the recipient to give feedback about the content of the message, the usefulness of the message, and the teacher's use of network computer system 100 to send messages to the recipient. As previously explained, the messages may be generated from one or more templates.

In at least one preferred embodiment of the present invention, a number of surveys may be generated for transmission to individuals and organizations affiliated with the system. Additionally, the survey messages are dynamic in nature and can be used to track patterns and trends based on user response. For example, if a parent provides a negative response to a survey question, network computer system 100 may be configured to mark the response for follow up. After a period of time or after a response by the administrators, network computer system 100 may be configured (automatically or after confirmation) to send out a follow-up survey to see if the parent feels more positively about the issue given the response to the situation by the school or the school district.

In addition, for the most preferred embodiments of the present invention, a mobile application or mobile “app” (e.g., a software application for smart phones or other mobile devices) is provided that will interface with network computer system 100. Via the mobile application, network computer system 100 allows an administrator to select which individual or individuals will receive messages and surveys and what types of surveys will those individuals will receive. For example, a supervisor may determine from the dashboard metrics that the parents have a less than optimal opinion of the counseling office. Network computer system 100 can then send survey messages about general topics or more targeted questions and surveys about the counseling office when parents with GPS or GIS tracking enabled are within a threshold distance from the counseling office. Alternatively, students who are leaving a school dance and who are carrying a mobile device that has GPS or GIS tracking enabled can be identified to receive a message or a survey about the school dance if the student has traveled a predetermined distance from the dance location.

In yet another preferred embodiment of the present invention, various ratios can be tracked and analyzed to determine areas of focus for review. For example, it will be possible to calculate student attendance by gender, age, grade, etc. and create a ratio to characterize the metrics. The ratios can be combined for further quantification. For example, the total attendance ratio (the attendance for all available students at a given school for a period of time) can be divided into the 3^{rd} grade class attendance ratio (total attendance for all available 3^{rd} grade students at the same school) to generate yet a third ratio. By using ratio analysis over time, the trends in the attendance of 3^{rd} graders relative to the total attendance of all students can be monitored and reported. Similar ratios can be developed for other metrics as well.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that fall within the meaning and range of equivalency of the claims are to be embraced within their scope.

1. A network computer system comprising:
at least one processor;
at least one memory coupled to the at least one processor;
at least one database residing in the at least one memory, the at least one database comprising data about at least one organization;
a data mechanism residing in memory, the data mechanism being configured to:
connect to the at least one database over a network;
obtain raw data about the at least one organization from the at least one database;
programmatically create metric data from the raw data;
calculate at least one overall value for a category from the metric data; and
send the metric data to a dashboard, the dashboard comprising a user interface and wherein the dashboard is further configured to display, via the user interface, in at least one data section:
the metric data;
a category name;
the at least one overall value representing the category of metric data with which the at least one data section is associated; and
an expandable list configured to expand when the dashboard has received a request from a user to select a data section, the expandable list comprising a plurality of metric pairs wherein each metric pair comprises a metric name associated with a metric value.

2. The system of claim 1 wherein the data mechanism is further configured to calculate metric data for a user-specified period of time and wherein the dashboard is further configured to display the calculated metric data for the user-specified period of time.

3. The system of claim 1 wherein the data mechanism further comprises a metric builder, the metric builder being configured to:
receive from the user a request to designate at least one metric;
designate at least one designated metric wherein the at least one designated metric comprises at least one item selected from the group consisting of: a ratio of two or more metrics; a ratio of two or more metrics calculated as a function of time; and a metric calculated as a function of time;
calculate a calculated designated metric data; and
display the calculated designated metric data in a dashboard.

4. The system of claim 3 wherein the data mechanism is further configured to monitor the metric data of the at least one designated metric as the metric data is updated in the database and wherein when at least one of the at least one designated metric reaches a default or pre-determined threshold, the system is configured to automatically send an alert to a user or display a message through the user interface.

5. The system of claim 4 wherein the database is configured to store updated metric data of a plurality of organizations, wherein at least one of the plurality of organizations are organized into a hierarchy of organizations; and wherein the data mechanism is further configured to compare the metric data from the plurality of organizations to the metric data of an organization of the user to determine an organization of the plurality of organizations which is similar to the organization of the user.

6. The system of claim 5 wherein the system is further configured to record at least one user response to the change in metric data of at least one user-selected metric; and wherein the at least one user response recorded is at least one selected from a list consisting essentially of: a note; a response to a survey; and a log of actions taken by one or more users of the system.

7. The system of claim 6 wherein the system is configured to track changes in the metric data of at least one organization during a user-selected period of time; and wherein the system is configured to:
use an algorithm to select recommended actions from a list of recommended action;
recommend actions to at least one user for improving the overall score of the at least one organization, through the dashboard; and
display the recommended actions via the dashboard to the user.

8. The system of claim 7 wherein the system is configured to display the list of recommended actions as an expandable list and receive a selection from a user to perform a recommended action, wherein the recommended action is at least one action selected from a group consisting essentially of: sending a message to a group; sending a congratulatory message to the individuals, parents of individuals, or associates of individuals who had metric data values for a metric or category which were greater than a threshold; and sending a warning message to the individual, parent of individuals, or associates of individuals who had metric data values for a metric value or a category which were less than a threshold.

9. The system of claim 8 wherein the system is configured to display to a user a suggestion that the user follow at least one selected from the group consisting of other users and organizations and the system is further configured to use at least one selected from the group consisting of metrics and recorded actions to determine the users or organizations which are suggested in the suggestion.

10. The system of claim 1 further configured to allow the user to communicate with at least one other user or organization who is using the system of claim 1 and further configured to communicate with an application on a mobile device, wherein the system is configured to receive GIS information from the mobile device and automatically send at least one message or survey to the mobile device when the distance of the mobile device from a user-selected location is greater than a user-selected threshold.

11. The system of claim 1 wherein the category is selected from a group consisting essentially of: parent outreach metrics; parent activity metrics; community activity metrics; attendance metrics; grade metrics; and community outreach metrics.

12. A computer implemented method for analyzing and displaying metric data in a network computer system, the method comprising the steps of:
connecting to the at least one database over a network; and
obtaining raw data about the at least one organization from the database; and
calculating calculated metric data from the raw data; and
calculating from the metric data at least one overall value for a category; and
sending the metric data to a dashboard user interface; and
displaying at least one data section within the dashboard, the data section comprising:
the calculated metric data, and
a category name, and
the overall value representing a category of metric data with which the at least one data section is associated, and
an expandable list configured to expand when the dashboard has received a request from a user to select a data section, the expandable list comprising:
a plurality of metric pairs wherein each metric pair comprises a metric name associated with a metric value.

13. The method of claim 12 further comprising the step of calculating metric data for a user-specified period of time and displaying the calculated metric data for the user-specified period of time through the dashboard.

14. The method of claim 12 further comprising the steps of:
building a custom metric:
receiving from the user a request to designate at least one metric; and
designating at least one designated metric, the at least one designated metric comprising:
at least one thing selected from the group consisting of a ratio of two or more metrics;
a ratio of two or more metrics calculated as a function of time; and
a metric calculated as a function of time;
calculating a calculated designated metric data; and
displaying the calculated designated metric data in the dashboard.

15. The method of claim 12 further comprising the steps of:
monitoring the metric data of the at least one designated metric as the metric data is updated in the database; and
automatically sending an alert to a user or displaying a message through the user interface when at least one of the at least one designated metric reaches a default or pre-determined threshold.

16. The method of claim 12 further comprising the steps of:
storing updated metric data of a plurality of organizations, wherein at least one of the plurality of organizations is organized into a hierarchy of organizations;
comparing the metric data from the plurality of organizations to the metric data of an organization of the user; and
determining an organization of the plurality of organizations which is similar to the organization of the user.

17. The method of claim 12 further comprising the step of recording at least one user response to the change in metric data of at least one user-selected metric, the at least one user response recorded essentially comprising:
a note;
a response to a survey; and
a log of actions taken by one or more users of the system.

18. The method of claim 12 further comprising the steps of:
tracking changes in the metric data of at least one organization during a user-selected period of time;
using an algorithm to select recommended actions from a list of recommended action;
recommending, through the dashboard, actions to at least one user for improving the overall score of the at least one organization; and
displaying the recommended actions via the dashboard to the user.

19. The method of claim 12 further comprising the steps of:
displaying the list of recommended actions as an expandable list; and
receiving a selection from a user to perform a recommended action; the recommended action being at least one action selected from a group consisting essentially of: sending a message to a group; sending a congratulatory message to the individuals, parents of individuals, or associates of individuals who had metric data values for a metric or category which were greater than a threshold; and sending a warning message to the individual, parent of individuals, or associates of individuals who had metric data values for a metric value or a category which were less than a threshold.

20. The method of claim 12 further comprising the steps of:
displaying a suggestion that a user follow at least one group selected from the group consisting of other users and organizations; and
determining the users or organizations which are suggested in the suggestion by using at least one data element selected from the group consisting of metrics and recorded actions.

21. The method of claim 12 further comprising the steps of:
allowing the user to communicate with at least one other user or organization;
communicating with an application on a mobile device;
receiving GPS information from the mobile device; and
automatically sending at least one message or survey to the mobile device when the distance of the mobile device from a user-selected location is greater than a user-selected threshold.

22. The method of claim 12 further comprising the step of selecting at least one category, the category selected from a group consisting essentially of: parent outreach metrics; parent activity metrics; community activity metrics; attendance metrics; grade metrics; and community outreach metrics.
